(19) United States
(12) Patent Application Publication
(10) Pub. No.: US 2026/0086392 A1
(43) Pub. Date: Mar. 26, 2026

(54) Contact Lenses With Image Quality Enhancing Annular Zone

(71) Applicant: Clerio Vision, Inc., Rochester, NY (US)

(72) Inventors: Leonard Zheleznyak, Pittsford, NY (US); Gustavo A. Gandara-Montano, Rochester, NY (US)

(73) Assignee: Clerio Vision, Inc., Rochester, NY (US)

(21) Appl. No.: 19/404,812

(22) Filed: Dec. 1, 2025

Related U.S. Application Data
(63) Continuation of application No. PCT/US2024/031905, filed on May 31, 2024.
(60) Provisional application No. 63/470,483, filed on Jun. 2, 2023.

(51) Int. Cl. G02C 7/04

(52) U.S. Cl. CPC G02C 7/044; G02C 2202/20; G02C 2202/24

(57) ABSTRACT

Contact lenses include a central zone with a subsurface optical structure and an annular zone configured to complement the central zone to provide increased image quality. A contact lens includes a central zone and an annular zone that surrounds the central zone. The central zone includes a central zone subsurface diffractive optical structure configured to produce a central zone wavefront that comprises a diffractive component. The annular zone is configured to produce an annular zone wavefront that constructively interferes with the central zone wavefront to enhance image quality.

### CROSS-REFERENCES TO RELATED APPLICATION

The present application is a Continuation of PCT/US2024/031905 filed May 31, 2024; which claims the benefit of priority to U.S. Provisional Appln. No. 63/470,483 filed Jun. 2, 2023, the full disclosures which are incorporated herein by reference in their entirety for all purposes.

### BACKGROUND

Optical aberrations that degrade visual acuity are common. Optical aberrations are imperfections of the eye that degrade focusing of light onto the retina. Common optical aberrations include lower-order aberrations (e.g., astigmatism, positive defocus (myopia) and negative defocus (hyperopia)) and higher-order aberrations (e.g., spherical aberrations, coma and trefoil).

Existing treatment options for correcting optical aberrations include glasses, contact lenses, and reshaping of the cornea via laser eye surgery. Additionally, an intraocular lens is often implanted in an eye. For example, an intraocular lens can be implanted to replace a native lens removed during cataract surgery.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments described herein are directed to multifocal contact lenses that include a central zone subsurface diffractive optical structure and an annular zone subsurface non-diffractive optical structure. In embodiments, the central zone subsurface diffractive optical structure provides a diffractive multifocal optical correction and can have an outer diameter corresponding to the applicable day-light pupil diameters. In embodiments, the annular zone subsurface non-diffractive optical structure surrounds the central zone subsurface diffractive optical structure and is configured to provide a non-zero optical wave change that combines with the diffractive multifocal optical correction to enhance image quality, especially for distance vision and low-light pupil diameters.

Thus, in one aspect, a contact lens includes a central zone and an annular zone. The contact is formed from a contact lens material having a lens material refractive index. The central zone includes a central zone subsurface diffractive optical structure. The central zone subsurface diffractive optical structure includes central zone refractive indices that differ from the lens material refractive index. The central zone subsurface diffractive optical structure is configured to produce a central zone wavefront that includes a diffractive component. The annular zone surrounds the central zone. The annular zone includes an annular zone subsurface non-diffractive optical structure. The annular zone subsurface non-diffractive optical structure includes annular zone refractive indices that differ from the lens material refractive index. The annular zone subsurface non-diffractive optical structure is configured to produce an annular zone wavefront configured to combine with the central zone wavefront to enhance image quality.

In many embodiments, the annular zone wavefront is configured to combine with the central zone wavefront via constructive interference. In some embodiments, the annular zone is configured to induce a constant piston optical correction essentially throughout the annular zone.

In addition, the central zone subsurface optical structure can have a phase-wrapped configuration that induces varying optical wave changes and the constant piston optical correction induces an optical wave change within 0.2 optical waves of the median of the varying optical wave changes. In some embodiments, the constant piston optical correction provides an optical wave change within 0.1 optical waves of the median of the varying optical wave changes. In some embodiments, the varying optical wave changes are within a range from 0.0 waves to 1.0 waves. In some embodiments, the varying optical wave changes are within a range from 0.0 waves to 0.75 waves.

In some embodiments, the central zone subsurface optical structure has a phase-wrapped configuration that induces varying optical wave changes and the annular zone optical correction provides an optical wave change within 0.2 optical waves of the median of the varying optical wave changes. In some embodiments, the annular zone optical correction provides an optical wave change within 0.1 optical waves of the median of the varying optical wave changes. In some embodiments, the varying optical wave changes are within a range from 0.0 waves to 1.0 waves. In some embodiments, the varying optical wave changes are within a range from 0.0 waves to 0.75 waves.

The central zone and the annular zone can have any suitable outer diameters. For example, in many embodiments, the central zone subsurface diffractive optical structure has an outer diameter of at least 3 mm and the annular zone subsurface non-diffractive optical structure has an outer diameter of at least 4 mm. In some embodiments, the central zone subsurface diffractive optical structure has an outer diameter of at least 4 mm and the annular zone subsurface non-diffractive optical structure has an outer diameter of at least 5.5 mm.

In some embodiments, the central zone wavefront is configured to treat presbyopia. In some embodiments, the central zone wavefront is configured to provide a diffractive bifocal correction configured to treat presbyopia. In some embodiments, the central zone wavefront is configured to provide a diffractive trifocal correction configured to treat presbyopia.

In many embodiments, the annular zone provides a substantial increase in distance vision image quality. For example, in many embodiments, the annular zone subsurface non-diffractive optical structure provides at least a 50 percent increase in Strehl ratio at 555 nm wavelength for distance vision relative to if the annular zone was configured to provide no optical correction. In some embodiments, the annular zone subsurface non-diffractive optical structure provides at least a 100 percent increase in Strehl ratio at 555 nm wavelength for distance vision relative to if the annular zone was configured to provide no optical correction. In some embodiments, the annular zone subsurface non-diffractive optical structure provides at least a 50 percent increase in Retinal Image Quality at 555 nm wavelength for distance vision relative to if the annular zone was configured to provide no optical correction.

In another aspect, a contact lens includes a central zone and an annular zone. The contact is formed from a contact lens material having a lens material refractive index. The central zone includes a central zone subsurface diffractive optical structure including central zone refractive indices that differ from the lens material refractive index. The central zone subsurface diffractive optical structure is configured to produce a central zone wavefront that comprises a diffractive component. The central zone subsurface diffractive optical structure has a phase-wrapped configuration that induces varying optical wave changes, and wherein a median of the varying optical wave changes is within 0.1 optical waves of a whole number of optical waves. The annular zone surrounds the central zone. The annular zone is configured to not induce any change in optical wave outside a range from −0.05 optical waves to 0.05 optical wave. In some embodiments, the varying optical wave changes induced by the central zone cover a range of optical waves covering a span of at least 0.3 optical waves. In some embodiments, the varying optical wave changes induced by the central zone cover a range of optical waves covering a span of at least 0.5 optical waves. In some embodiments, the varying optical wave changes are within a range from 0.0 waves to 1.0 waves. In some embodiments, the varying optical wave changes are within a range from 0.0 waves to 0.75 waves.

The central zone and the annular zone can have any suitable outer diameters. For example, in many embodiments, the central zone subsurface diffractive optical structure has an outer diameter of at least 3 mm and the annular zone subsurface non-diffractive optical structure has an outer diameter of at least 4 mm. In some embodiments, the central zone subsurface diffractive optical structure has an outer diameter of at least 4 mm and the annular zone subsurface non-diffractive optical structure has an outer diameter of at least 5.5 mm.

In some embodiments, the central zone wavefront is configured to treat presbyopia. In some embodiments, the central zone wavefront is configured to provide a diffractive bifocal correction configured to treat presbyopia. In some embodiments, the central zone wavefront is configured to provide a diffractive trifocal correction configured to treat presbyopia.

For a fuller understanding of the nature and advantages of the present invention, reference should be made to the ensuing detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a contact lens including a central zone that includes a subsurface diffractive optical structure and an annular zone that includes a subsurface non-diffractive optical structure in accordance with embodiments.

FIG. 2 shows a contour plot of optical waves induced by an example central zone for the contact lens of FIG. 1 in which the subsurface diffractive optical structure provides a tri-focal correction.

FIG. 3 shows a plot of the optical waves induced by the example central zone of FIG. 2.

FIG. 4 shows a plot of the Strehl Ratio as a function of defocus for the example central zone of FIG. 2 and a pupil diameter matching the outer diameter of the central zone.

FIG. 5 shows a plot of the Strehl Ratio as a function of defocus for the example central zone of FIG. 2 and a pupil diameter matching the outer diameter of the annular zone.

FIG. 6 shows a contour plot of optical waves induced by the example central zone of FIG. 2 and the annular zone of FIG. 1.

FIG. 7 shows a plot of the optical waves induced by the example central zone of FIG. 2 and candidate optical waves to be induced by corresponding candidate configurations of the annular zone.

FIG. 8 shows plots of the Strehl Ratio as a function of defocus for the example central zone of FIG. 2 and the candidate configurations of the annular zone of FIG. 7 for a pupil diameter matching the outer diameter of the annular zone.

FIG. 9 shows plots of the Strehl Ratio as a function of piston height in waves for distance vision, intermediate vision, and near vision for the example central zone of FIG. 2 and the candidate configurations of the annular zone of FIG. 7 for a pupil diameter matching the outer diameter of the annular zone.

FIG. 10 shows plots of the Retinal Image Quality as a function of piston height in waves for distance vision, intermediate vision, and near vision for the example central zone of FIG. 2 and the candidate configurations of the annular zone of FIG. 7 for a pupil diameter matching the outer diameter of the annular zone.

FIG. 11 illustrates one approach for configuring a contact lens with a central zone that provides a diffractive multifocal correction and an annular zone for producing constructive interference with the central zone, in accordance with embodiments.

FIG. 12 illustrates another approach for configuring a contact lens with a central zone that provides a diffractive multifocal correction and an annular zone for producing constructive interference with the central zone, in accordance with embodiments.

FIG. 13 illustrates another approach for configuring a contact lens with a central zone that provides a diffractive multifocal correction and an annular zone for producing constructive interference with the central zone, in accordance with embodiments.

FIG. 14 shows a plot of the optical waves induced by a multifocal contact lens with a central zone configured to provide a bifocal correction and an annular zone configured to not induce any wavefront change.

FIG. 15 shows a plot of the optical waves induced by a multifocal contact lens with the central zone of the multifocal contact lens of FIG. 14 and an annular zone configured to induce a wavefront change to produce constructive interference with light passing through the central zone.

FIG. 16 shows a plot of the optical waves induced by a multifocal contact lens with a central zone configured to provide a trifocal correction and an annular zone configured to not induce any wavefront change.

FIG. 17 shows a plot of the optical waves induced by a multifocal contact lens with the central zone of the multifocal contact lens of FIG. 16 and an annular zone configured to induce a wavefront change to produce constructive interference with light passing through the central zone.

FIG. 18 illustrates the results of testing of distance visual acuity for the multifocal contact lenses of FIG. 14, FIG. 15, FIG. 16, and FIG. 17.

FIG. 19 is a schematic representation of a system that can be used to form subsurface optical elements within an ophthalmic lens, in accordance with embodiments.

FIG. 20 and FIG. 21 schematically illustrate another system that can be used to form subsurface optical elements within an ophthalmic lens, in accordance with embodiments.

FIG. 22 illustrates an example radial distribution of an optical correction for implementation via subsurface optical elements formed within an ophthalmic lens, in accordance with embodiments.

FIG. 23 illustrates a 1-wave phase wrapped distribution for the example optical correction of FIG. 22.

FIG. 24 illustrates a ⅓ wave ratio of the 1-wave phase wrapped distribution of FIG. 23.

FIG. 25 graphically illustrates diffraction efficiency for near focus and far focus versus optical phase height.

FIG. 26 graphically illustrates an example calibration curve for resulting optical phase change height as a function of laser pulse train optical power.

FIG. 27 is a plan view illustration of an ophthalmic lens that includes subsurface optical structures, in accordance with embodiments.

FIG. 28 is a plan view illustration of subsurface optical structures of the ophthalmic lens of FIG. 27.

FIG. 29 is a side view illustration of the subsurface optical structures of the ophthalmic lens of FIG. 28.

### DETAILED DESCRIPTION

In the description herein, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

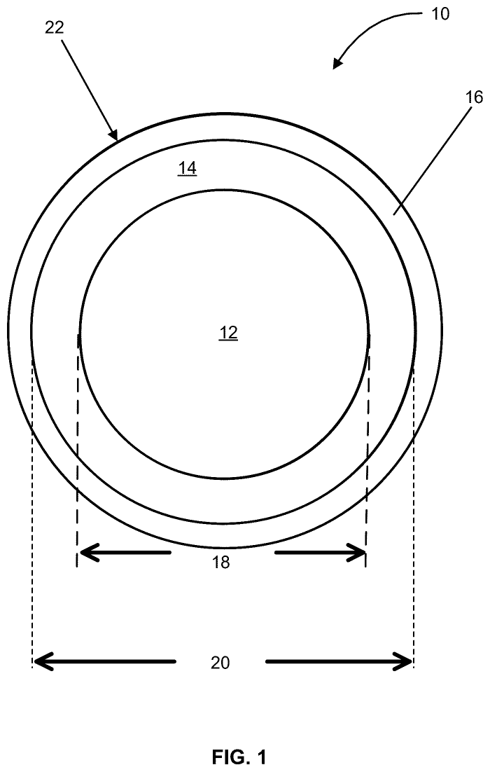

Turning now to the drawing figures in which similar reference numbers refer to similar features in the various drawing figures, FIG. 1 illustrates a contact lens 10 that includes a central zone 12, an annular zone 14, and a perimeter zone 16. The central zone 12 has a central zone outer diameter 18. The annular zone 14 surrounds and extends radially from the central zone 12. The annular zone 14 has an annular zone outer diameter 20. The perimeter zone 16 surrounds and extends radially from the annular zone 14 to a perimeter edge 22 of the contact lens 10. In embodiments, the central zone outer diameter 18 is sized to match or approximately match a target day-light pupil diameter for a wearer of the contact lens 10. In embodiments, the annular zone outer diameter 20 is sized to match or approximately match a target low-light pupil diameter for the wearer of the contact lens 10. For example, in many embodiments, the central zone outer diameter 18 is at least 3 mm and the annular zone outer diameter is at least 4 mm. In some embodiments, the central zone outer diameter 18 is at least 4 mm and the annular zone outer diameter is at least 5.5 mm. In some embodiments, the central zone outer diameter 18 is 4.5 mm and the annular zone outer diameter 20 is 6.0 mm. In many embodiments, the central zone 12 includes a central zone subsurface diffractive optical structure configured to produce a central zone diffractive multifocal wavefront to enhance through-focus image quality. In many embodiments, the annular zone 14 includes an annular zone subsurface non-diffractive structure configured to produce an annular zone wavefront configured to combine with the central zone diffractive multifocal wavefront to enhance image quality-especially for distance vision during low-light conditions as described herein.

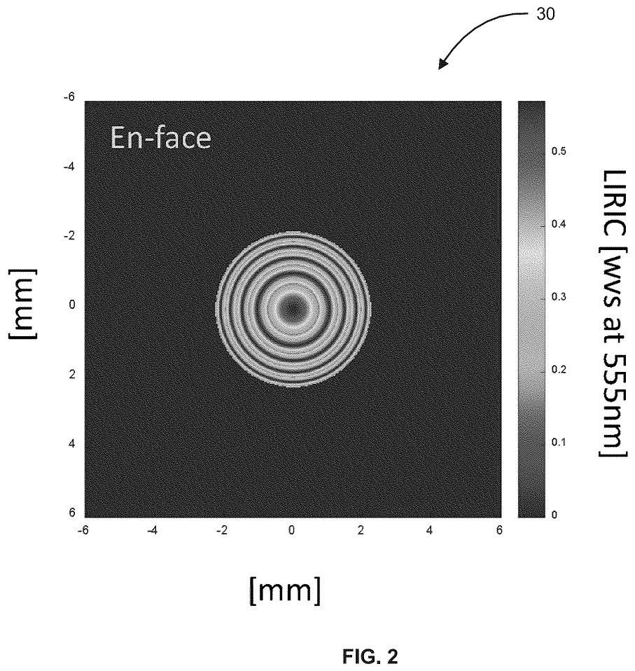

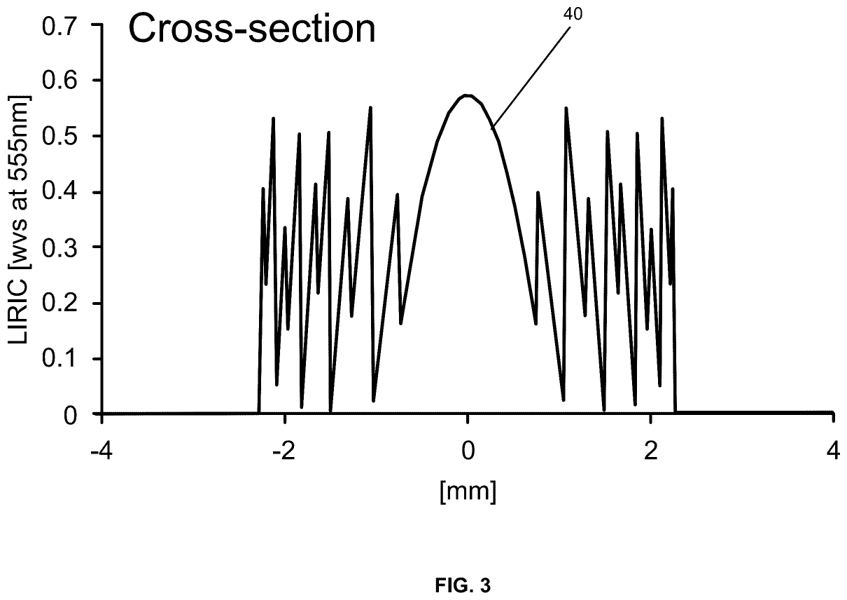

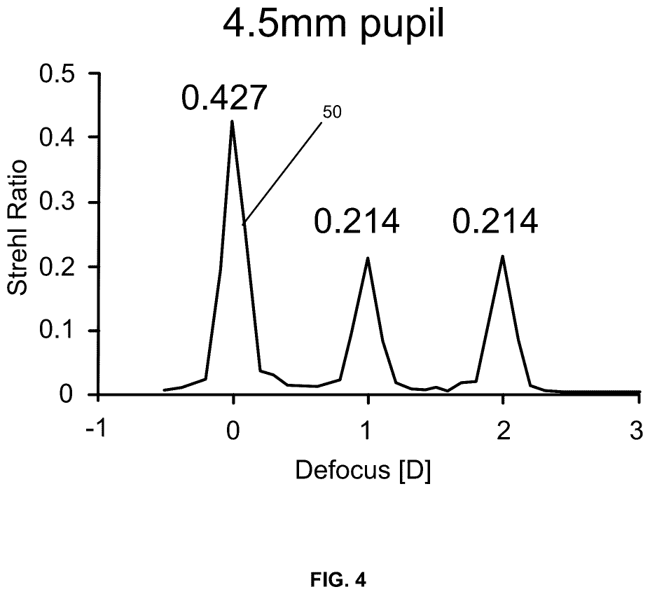

FIG. 2 shows a contour plot 30 of optical waves induced by an example central zone 12 configured to provide a diffractive tri-focal correction. FIG. 3 shows a plot 40 of the optical waves induced by a cross-section of the example central zone 12. As shown, the example central zone 12 produces a central zone diffractive multifocal wavefront in which the induced optical waves vary radially in a range between 0.0 waves and about 0.58 waves. FIG. 4 shows a plot of Strehl Ratio 50 as a function of defocus for the example central zone and a 4.5 mm pupil size, which matches the central zone outer diameter 18 for the example central zone 12. As shown, Strehl Ratio 50 varies through-focus with a maximum of 0.427 at 0 diopter defocus (for distance vision) and local maximums of 0.214 at each of 1.0 diopter defocus (for intermediate vision) and 2.0 diopter defocus (for near vision).

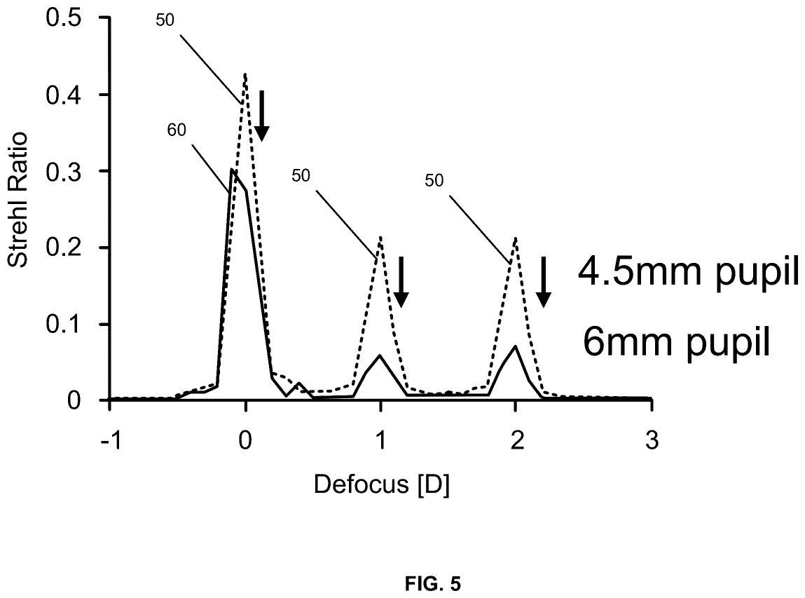

In many embodiments, the central zone diameter 18 matches or approximately matches a day-light pupil size and therefore contributes to day-time distance vision, intermediate vision, and near vision; the annular zone 14 is largely blocked by the iris for a day-light pupil size; and the annular zone 14 only contributes to vision for increased pupil sizes corresponding to low-light conditions. FIG. 5 shows the plot of Strehl Ratio 50 (for the 4.5 mm pupil) and a plot of Strehl Ratio 60 as a function of defocus for an example configuration of the contact 10 that employs the example central zone 12 and an annular zone 14 that does not induce any wavefront change. The plot of Strehl Ratio 60 is produced using a 6 mm pupil diameter, which is equal to the annular zone outer diameter 20. As shown, the increase in pupil diameter from 4.5 mm to 6.0 mm reduces the peak Strehl Ratios for each of distance vision (at 0 diopter defocus), intermediate vision (at 1 diopter defocus), and near vision (at 2 diopter defocus).

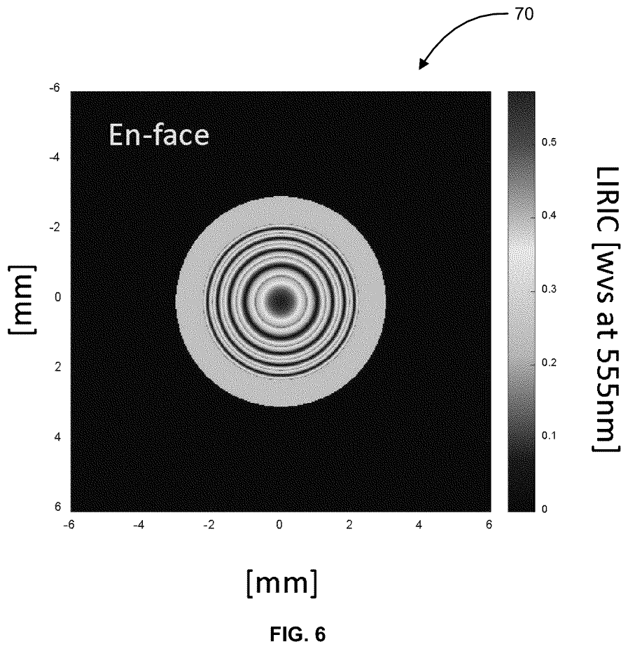

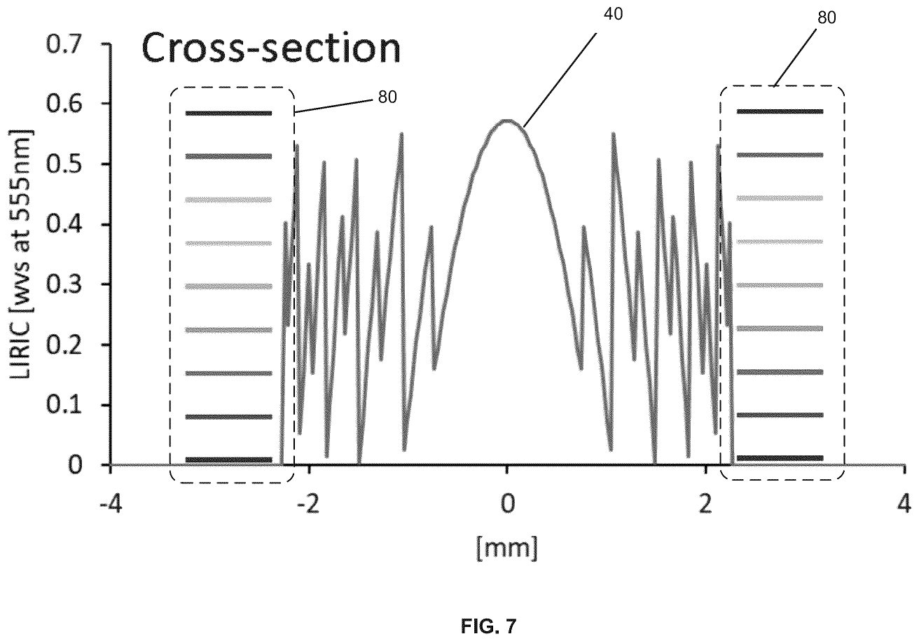

In many embodiments, the annular zone 14 includes an annular zone subsurface optical structure configured to provide a non-zero optical wave change(s) configured to combine with the central zone wavefront to improve image quality relative to where the annular zone 14 does not induce any wavefront change. FIG. 6 shows a contour plot 70 of optical waves induced by the example central zone 12 and a candidate annular zone 14. FIG. 7 shows a plot 40 of the optical waves induced by the example central zone 12 and candidate optical waves 80 for corresponding candidate configurations of the annular zone 14.

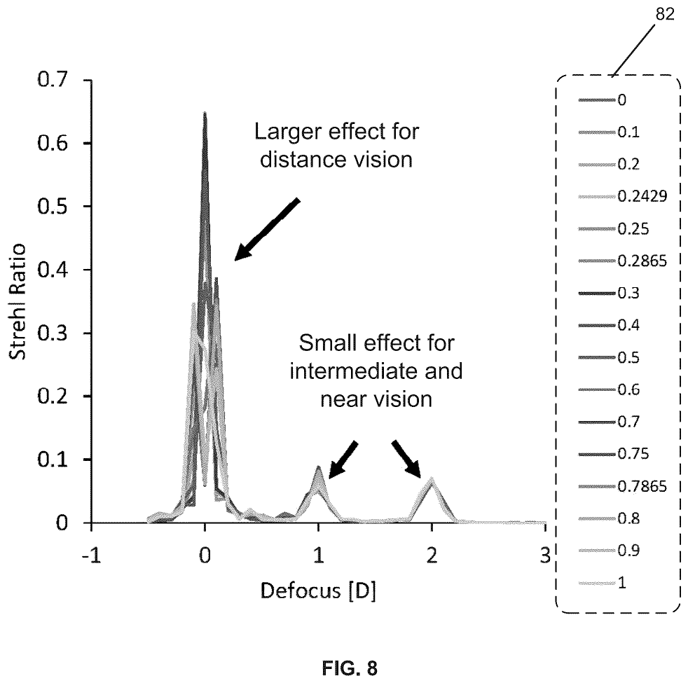

FIG. 8 shows plots of Strehl Ratio as a function of defocus for the example central zone 12 and candidate configurations of the annular zone 14, each of which provided a constant piston change in a respective magnitude in waves shown in the plot legend 82. As shown, the different candidate configurations of the annular zone 14 assessed produced a larger variation in peak Strehl Ratio at 0 diopter defocus (distance vision) than for the local maximum peaks at 1 diopter defocus (intermediate vision) and 2 diopter defocus (near vision).

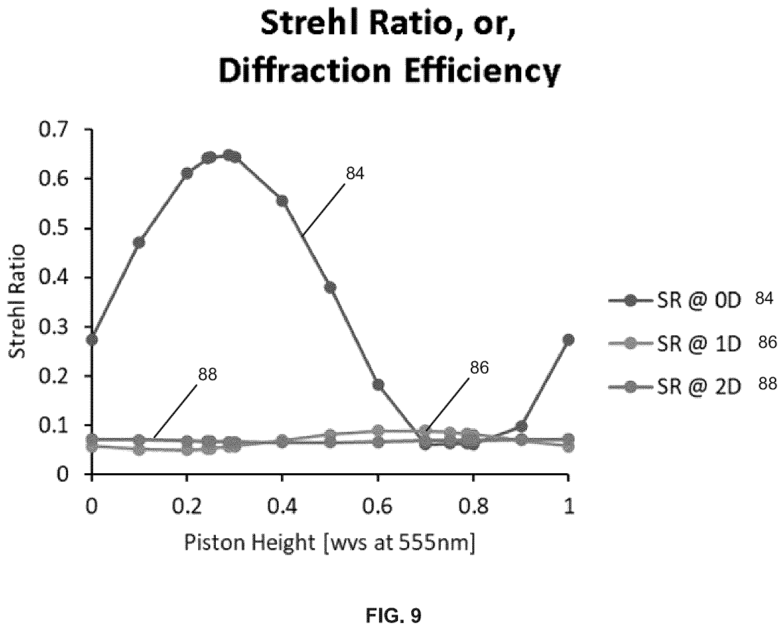

FIG. 9 shows plots 84, 86, 88 of Strehl Ratio as a function of piston height in waves (at 555 nm wavelength) for distance vision (plot 84), intermediate vision (plot 86), and near vision (plot 88) for the example central zone 12 and the candidate configurations of the annular zone 14 with a pupil diameter matching the annular zone outer diameter 20. As shown, Strehl Ratio for distance vision (plot 84) is maximized with an annular zone 14 that induces a piston height of about 0.28 waves. Strehl Ratios for intermediate vision (plot 86) and for near vision (plot 88) do not exhibit large changes as a function of piston height in waves.

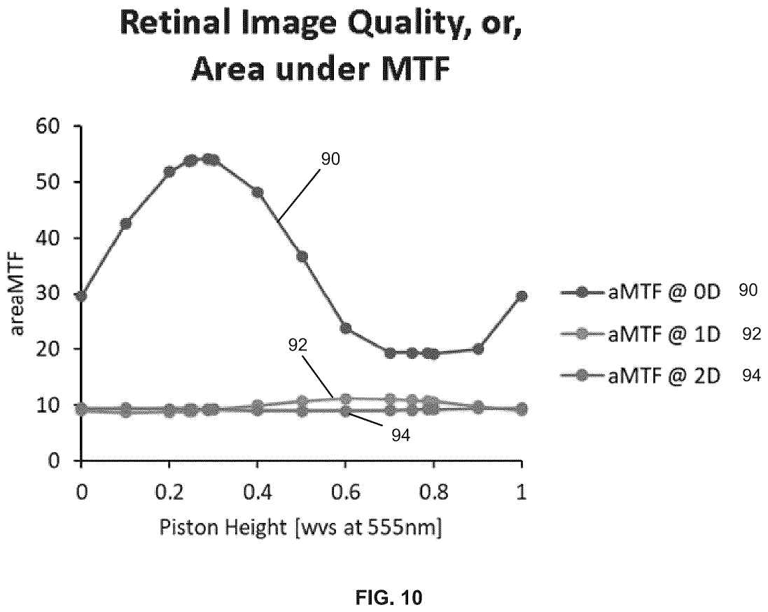

FIG. 10 shows plots 90, 92, 94 of Retinal Image Quality as a function of piston height in waves for distance vision (plot 90), intermediate vision (plot 92), and near vision (plot 94) for the example central zone 12 and the candidate configurations of the annular zone 14 with a pupil diameter matching the annular zone diameter 20. As shown, Retinal Image Quality for distance vision (plot 84) is maximized with an annular zone 14 that produces a piston height of about 0.28 waves. Retinal Image Quality for intermediate vision (plot 86) and for near vision (plot 88) do not exhibit large changes as a function of piston height in waves. The larger impact of the annular zone on distance vision than for intermediate vision or near vision may be due to the annular zone 14 having insufficient optical power relative to optical powers suitable for intermediate vision (e.g., 1 diopter) and near vision (e.g., 2 diopter) as compared to distance vision (e.g., 0 diopter).

The exhibited maximization of image quality for distance vision with an annular zone 14 that produces a piston height of about 0.28 waves may be the product of constructive interference between the 0.28 waves provide by the annular zone 14 and the varying optical waves provided by the example central zone 12, which vary in a range between 0.0 waves and about 0.58 waves. The 0.28 waves provided by the annular zone 14 is approximately midway in the range of waves provided by the example central zone 12 and therefore would tend to maximize the amount of overall constructive interference with the light passing through the central zone 12.

### Configurational Approaches

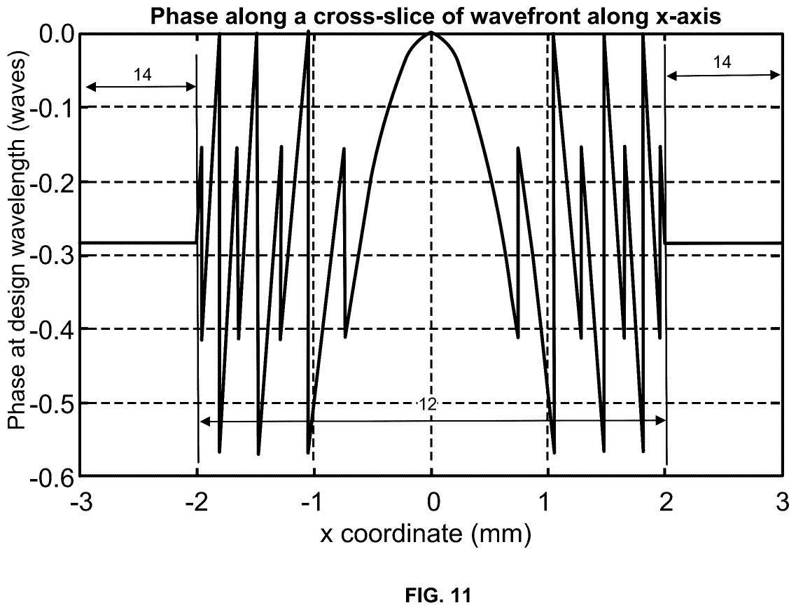

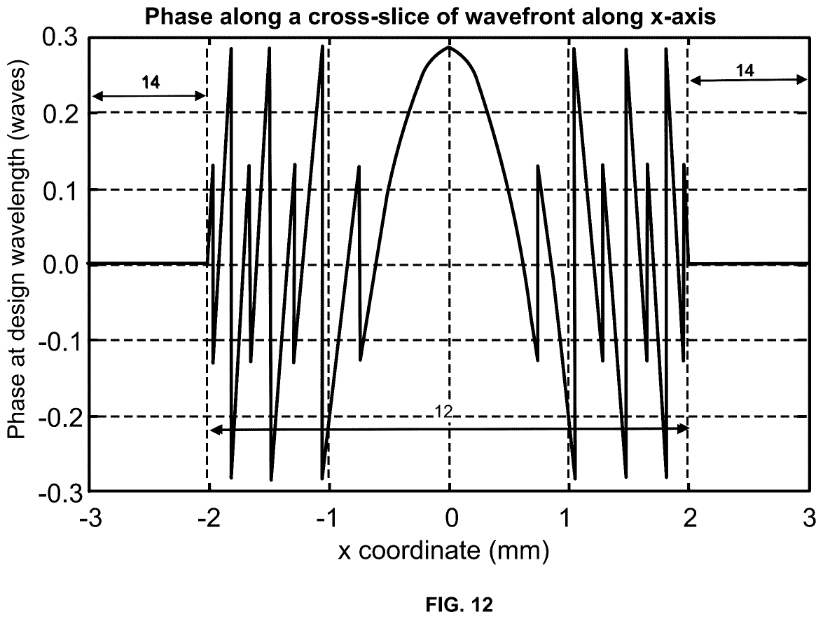

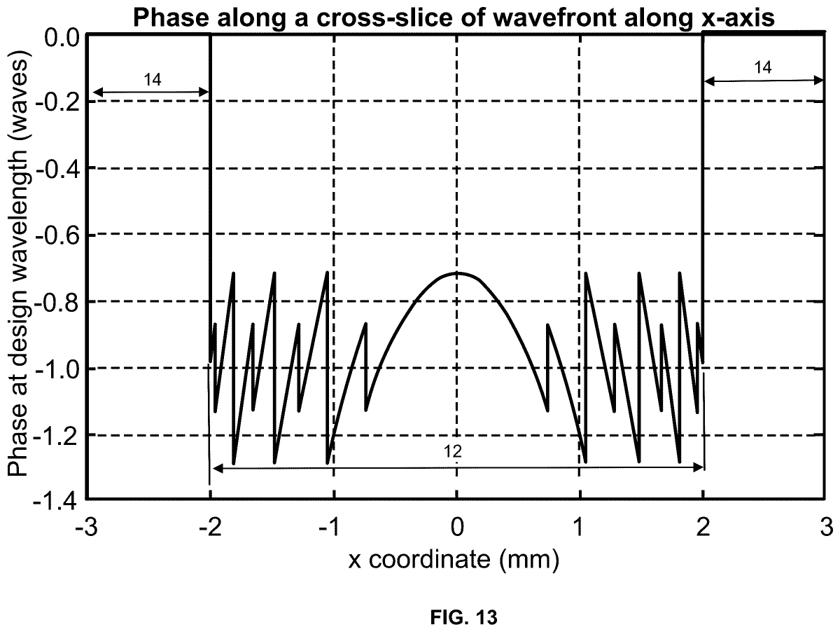

In many embodiments, the central zone 12 and the annular zone 14 are configured so that light passing through the annular zone 14 constructively interferes with light passing through the central zone 12 for distance vision, which can be achieved using a number of different configurational approaches. Any suitable approach can be used to maximize or nearly maximize the constructive interference including the approaches illustrated in FIG. 11, FIG. 12, and FIG. 13.

In the approach illustrated in FIG. 11, both the central zone 12 and the annular zone 14 are configured to induce changes in optical waves in the light passing through the respective zone. The annular zone 14 is configured to induce a suitable change in optical phase by an amount different from zero so that light passing through the annular zone 14 produces an annular zone wavefront that maximizes or nearly maximizes the amount of constructive interference for distance vision between the annular zone wavefront and a central zone wavefront produced via light passing through the central zone 12. The annular zone 14 can be configured to induce any suitable distribution of changes in optical waves in the light passing through the annular zone 14. In the embodiment illustrated in FIG. 11, the annular zone 14 induces a constant (piston) change in optical waves. Other distributions, such as any suitable non-constant distribution, that maximize or nearly maximizes the amount of constructive interference between the annular zone wavefront and the central zone wavefront can be used. The approach illustrated in FIG. 11 can be used to produce a delta of zero waves between the annular zone wavefront and the average or the median optical phase of the central zone wavefront.

In the approach illustrated in FIG. 12, the central zone 12 is configured to induce varying changes in optical waves to light passing through the central zone 12 so that the median or the average of the changes in optical waves is zero or within a small range optical waves that includes zero (e.g., within a range from −0.1 to 0.1 optical waves) and the annular zone 14 is configured to not induce any change in optical wave or at least not outside a relatively small range of optical waves that includes zero (e.g., from −0.05 optical waves to 0.05 optical waves). The central zone 12 induces both negative and positive changes in optical phase so that the median or the average induced change in optical waves is zero or within a small range optical waves that includes zero, thereby resulting in a delta of zero waves between the annular zone wavefront and the median or the average optical phase of the central zone wavefront.

In the approach illustrated in FIG. 13, the central zone 12 is configured to induce varying changes in optical waves to light passing through the central zone 12 so that the median or the average of the varying optical wave changes is within 0.1 optical waves of a whole number of optical waves and the annular zone 14 is configured to not induce any change in optical wave or at least not outside a range of optical waves that includes zero (e.g., from −0.05 optical waves to 0.05 optical waves). In the embodiment illustrated in FIG. 13, the central zone wavefront is offset by one optical wave from the central zone wavefront shown in FIG. 12. The central zone 12 induces changes in optical phase so that the median or the average induced change in optical waves is equal to a whole number of optical waves or within a small range optical waves that includes a whole number of optical waves, thereby maximizing or nearly maximizing the constructive interference for distance vision between the annular zone wavefront and the central zone wavefront.

### Distance Visual Acuity Assessment

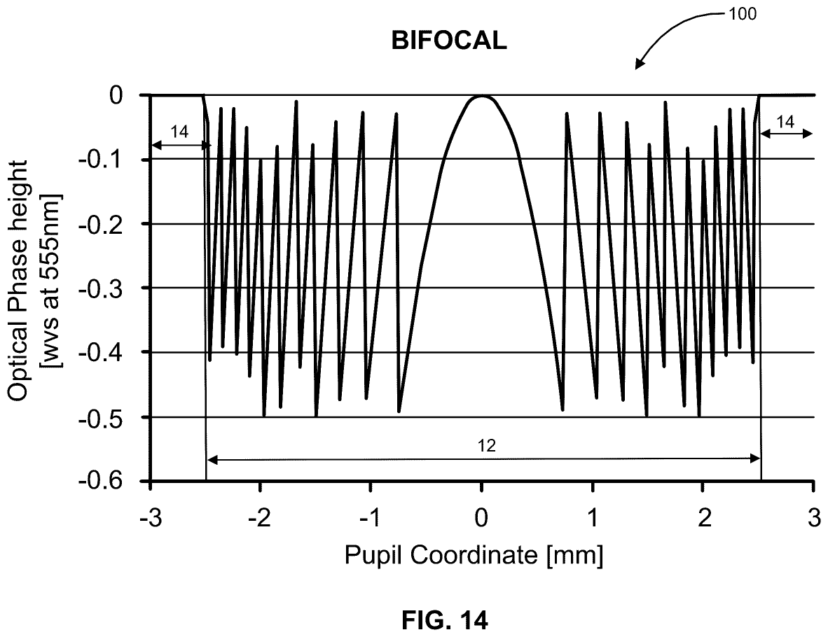

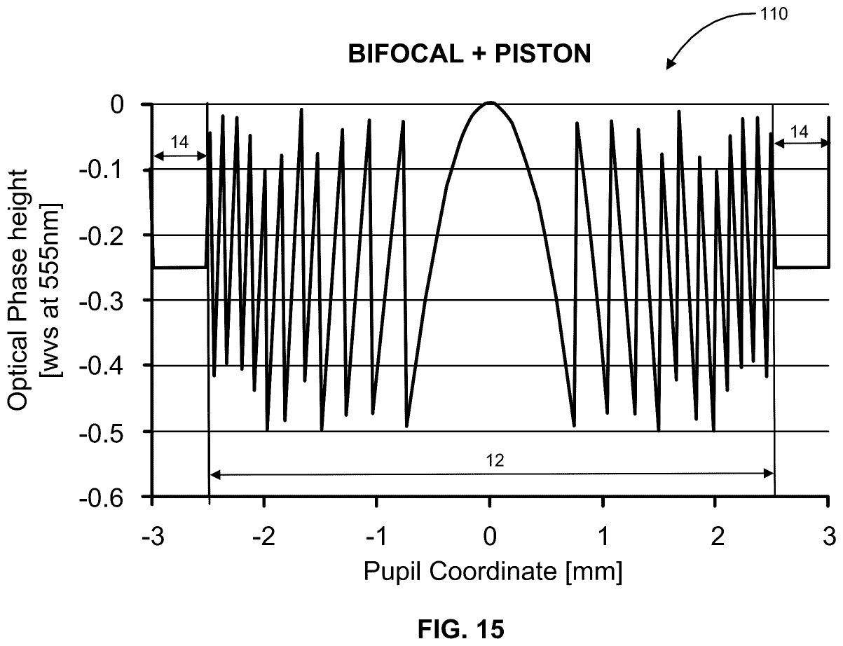

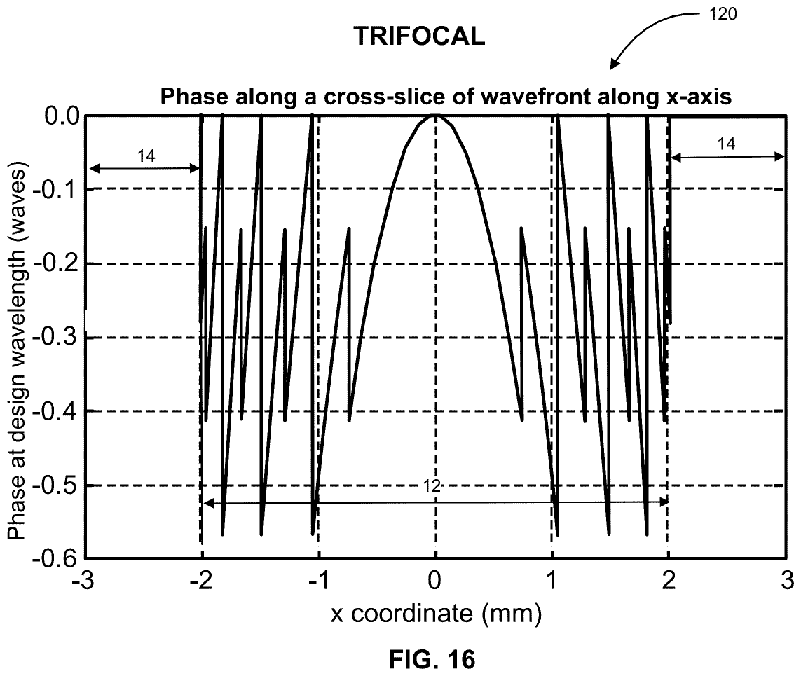

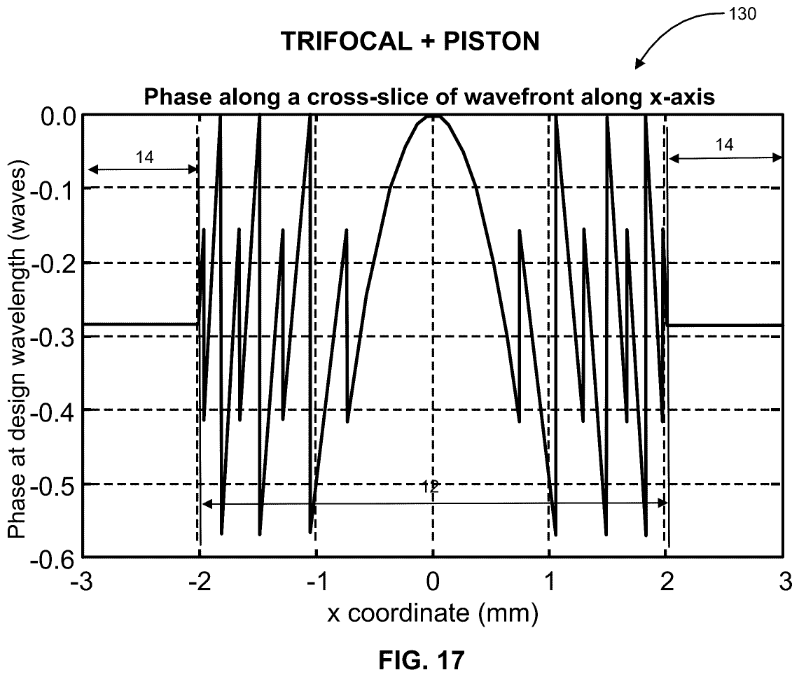

Distance visual acuity improvement provided by the approaches described herein was assessed using an Adaptive Optics (AO) visual simulator to simulate diffractive multifocal contact lenses (MCLs) with annular zones configured to either produce a peripheral piston correction or to not provide any peripheral correction. Subjects underwent visual acuity and visual preference tests using the simulated diffractive MCLs. FIG. 14 shows a plot 100 of the optical waves induced by a bifocal contact lens with a central zone 12 configured to provide a bifocal correction and an annular zone 14 configured to not induce any wavefront change. FIG. 15 shows a plot 110 of the optical waves induced by a multifocal contact lens with the central zone 12 of the multifocal contact lens of FIG. 14 and an annular zone 14 configured to induce a wavefront change to produce constructive interference with light passing through the central zone. FIG. 16 shows a plot 120 of the optical waves induced by a trifocal contact lens with a central zone configured to provide a trifocal correction and an annular zone configured to not induce any wavefront change. FIG. 17 shows a plot 130 of the optical waves induced by a trifocal contact lens with the central zone of the multifocal contact lens of FIG. 16 and an annular zone configured to induce a wavefront change to produce constructive interference with light passing through the central zone.

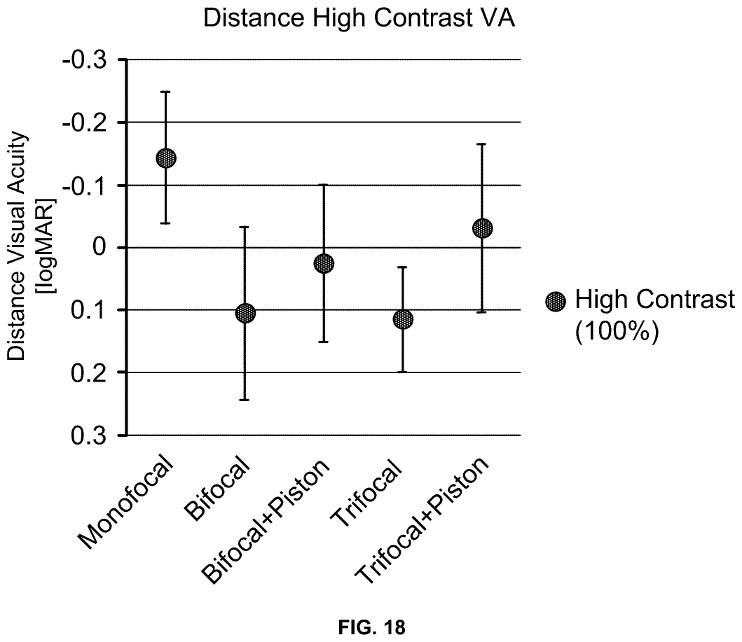

FIG. 18 illustrates the results of testing of distance visual acuity of presbyopic subjects for the multifocal contact lenses of FIG. 14, FIG. 15, FIG. 16, and FIG. 17. The data obtained by the testing shows that high contrast acuity improved about 1 line for the bifocal MFCs and 1.5 lines for the trifocal MFCs.

### Laser and Optical Systems for Forming Subsurface Optical Elements

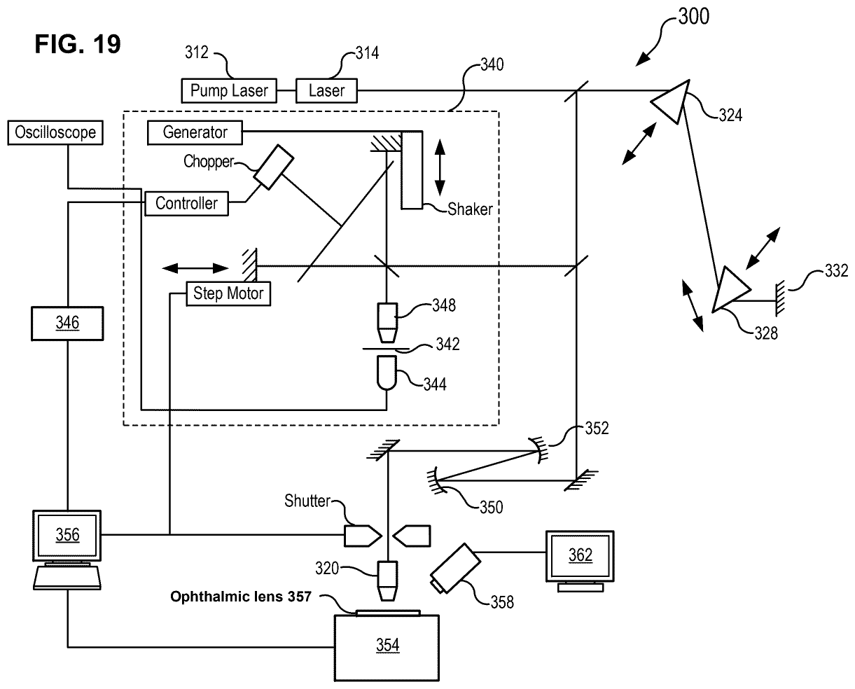

FIG. 19 is a schematic representation of the laser and optical system 300 that can be used to modify an ophthalmic lens to be configured to create high-quality vision for the patient and/or inhibit progression of myopia, in accordance with embodiments. The system 300 includes a laser source that includes a Kerr-lens mode-locked Ti:Sapphire laser 312 (Kapteyn-Mumane Labs, Boulder, Colo.) pumped by 4 w of a frequency-doubled Nd:YVO₄ laser 314. The laser generates pulses of 300 mW average power, 30 fs pulse width, and 93 MHz repetition rate at wavelength of 800 nm. Because there is a reflective power loss from the mirrors and prisms in the optical path, and In particular, from the power loss of the objective 320, the measured average laser power at the objective focus on the material is about 120 mW, which indicates the pulse energy for the femtosecond laser is about 1.3 nJ.

Due to the limited laser pulse energy at the objective focus, the pulse width can be preserved so that the pulse peak power is strong enough to exceed the nonlinear absorption threshold of the ophthalmic lens. Because a large amount of glass inside the focusing objective significantly increases the pulse width due to the positive dispersion inside of the glass, an extra-cavity, compensation scheme can be used to provide the negative dispersion that compensates for the positive dispersion introduced by the focusing objective. Two SF10 prisms 324 and 328 and one ending mirror 332 form a two-pass one-prism-pair configuration. A 37.5 cm separation distance between the prisms can be used to compensate the dispersion of the microscope objective and other optics within the optical path.

A collinear autocorrelator 340 using third-order harmonic generation is used to measure the pulse width at the objective focus. Both 2^{nd} and 3^{rd} harmonic generation have been used in autocorrelation measurements for low NA or high NA objectives. Third order surface harmonic generation (THG) autocorrelation was selected to characterize the pulse width at the focus of the high-numerical-aperture objectives because of its simplicity, high signal to noise ratio and sign of material dispersion that second harmonic generation (SHG) crystals usually introduce. The THG signal is generated at the interface of air and an ordinary cover slip 342 (Corning No. 0211 Zinc Titania glass) and measured with a photomultiplier 344 and a lock-in amplifier 346. After using a set of different high-numerical-aperture objectives and carefully adjusting the separation distance between the two prisms and the amount of glass inserted, a transform-limited 27-fs duration pulse was selected. The pulse is focused by a 60× 0.70NA Olympus LUCPlanFLN long-working-distance objective 348.

Because the laser beam will spatially diverge after it comes out of the laser cavity, a concave mirror pair 350 and 352 is added into the optical path in order to adjust the dimension of the laser beam so that the laser beam can optimally fills the objective aperture. A 3D 100 nm resolution DC servo motor stage 354 (Newport VP-25XA linear stage) and a 2D 0.7 nm resolution piezo nanopositioning stage (P1 P-622.2CD piezo stage) are controlled and programmed by a computer 356 as a scanning platform to support and locate an ophthalmic lens 357. The servo stages have a DC servomotor so they can move smoothly between adjacent steps. An optical shutter controlled by the computer with 1 ms time resolution is installed in the system to precisely control the laser exposure time. With customized computer programs, the optical shutter could be operated with the scanning stages to form the subsurface optical elements in the ophthalmic lens 357 with different scanning speed at different position and depth and different laser exposure time. In addition, a CCD camera 358 along with a monitor 362 is used beside the objective 320 to monitor the process in real time. The system 300 can be used to modify the refractive index of an ophthalmic lens to form subsurface optical elements that are configured to create high-quality vision for the patient and/or provide a myopia progression inhibiting optical correction for each of one or more locations in the peripheral retina.

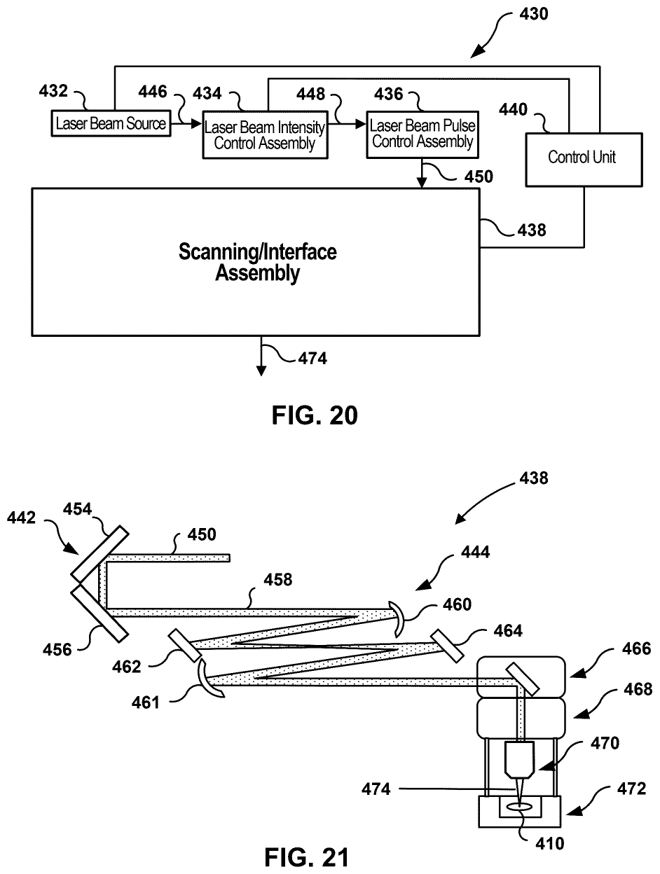

FIG. 20 is a simplified schematic illustration of another system 430 used for forming one or more subsurface optical structures within an ophthalmic lens 410, in accordance with embodiments. The system 430 includes a laser beam source 432, a laser beam intensity control assembly 434, a laser beam pulse control assembly 436, a scanning/interface assembly 438, and a control unit 440.

The laser beam source 432 generates and emits a laser beam 446 having a suitable wavelength for inducing refractive index changes in target sub-volumes of the ophthalmic lens 410. In examples described herein, the laser beam 446 has a 1035 nm wavelength. The laser beam 446, however, can have any suitable wavelength (e.g., in a range from 400 to 1100 nm) effective in inducing refractive index changes in the target sub-volumes of the ophthalmic lens 410.

The laser beam intensity control assembly 434 is controllable to selectively vary intensity of the laser beam 446 to produce a selected intensity laser beam 48 output to the laser beam pulse control assembly 436. The laser beam intensity control assembly 434 can have any suitable configuration, including any suitable existing configuration, to control the intensity of the resulting laser beam 448. In many instances, the laser beam intensity control assembly utilizes an acousto-optic modulator.

The laser beam pulse control assembly 436 is controllable to generate collimated laser beam pulses 450 having suitable duration, intensity, size, and spatial profile for inducing refractive index changes in the target sub-volumes of the ophthalmic lens 410. The laser beam pulse control assembly 436 can have any suitable configuration, including any suitable existing configuration, to control the duration of the resulting laser beam pulses 450.

The scanning/interface assembly 438 is controllable to selectively scan the laser beam pulses 450 to produce XYZ scanned laser pulses 474. The scanning/interface assembly 438 can have any suitable configuration, including any suitable existing configuration (for example, the configuration illustrated in FIG. 21) to produce the XYZ scanned laser pulses 474. The scanning/interface assembly 438 receives the laser beam pulses 450 and outputs the XYZ scanned laser pulses 474 in a manner that minimizes vignetting. The scanning/interface assembly 438 can be controlled to selectively scan each of the laser beam pulses 450 to generate XYZ scanned laser pulses 474 focused onto targeted sub-volumes of the ophthalmic lens 410 to induce the respective refractive index changes in targeted sub-volumes so as to form the one or more subsurface optical structures within an ophthalmic lens 410. In many embodiments, the scanning/interface assembly 438 is configured to restrain the position of the ophthalmic lens 410 to a suitable degree to suitably control the location of the targeted sub-volumes of the ophthalmic lens 410 relative to the scanning/interface assembly 438. In many embodiments, such as the embodiment illustrated in FIG. 21, the scanning/interface assembly 438 includes a motorized Z-stage that is controlled to selectively control the depth within the ophthalmic lens 410 to which each of the XYZ scanned laser pulses 474 is focused.

The control unit 440 is operatively coupled with each of the laser beam source 432, the laser beam intensity control assembly 434, the laser beam pulse control assembly 436, and the scanning/interface assembly 438. The control unit 440 provides coordinated control of each of the laser beam source 432, the laser beam intensity control assembly 434, the laser beam pulse control assembly 436, and the scanning/interface assembly 438 so that each of the XYZ scanned laser pulses 474 have a selected intensity and duration and are focused onto a respective selected sub-volume of the ophthalmic lens 410 to form the one or more subsurface optical structures within an ophthalmic lens 410. The control unit 440 can have any suitable configuration. For example, in some embodiments, the control unit 440 comprises one or more processors and a tangible memory device storing instructions executable by the one or more processors to cause the control unit 440 to control and coordinate operation of the of the laser beam source 432, the laser beam intensity control assembly 434, the laser beam pulse control assembly 436, and the scanning/interface assembly 438 to produce the XYZ scanned laser pulses 474, each of which is synchronized with the spatial position of the sub-volume optical structure.

FIG. 21 is a simplified schematic illustration of an embodiment of the scanning/interface assembly 438. In the illustrated embodiment, the scanning/interface assembly 438 includes an XY galvo scanning unit 442, a relay optical assembly 444, a Z stage 466, an XY stage 468, a focusing objective lens 470, and a patient interface/ophthalmic lens holder 472. The XY galvo scanning unit 438 includes XY galvo scan mirrors 454, 456. The relay optical assembly 440 includes concave mirrors 460, 461 and plane mirrors 462, 464.

The XY galvo scanning unit 442 receives the laser pulses 450 (e.g., 1035 nm wavelength collimated laser pulses) from the laser beam pulse control assembly 436. In the illustrated embodiment, the XY galvo scanning unit 442 includes a motorized X-direction scan mirror 454 and a motorized Y-direction scan mirror 456. The X-direction scan mirror 454 is controlled to selectively vary orientation of the X-direction scan mirror 454 to vary direction/position of XY scanned laser pulses 458 in an X-direction transverse to direction of propagation of the XY scanned laser pulses 458. The Y-direction scan mirror 456 is controlled to selectively vary orientation of the Y-direction scan mirror 456 to vary direction/position of the XY scanned laser pulses 458 in a Y-direction transverse to direction of propagation of the XY scanned laser pulses 458. In many embodiments, the Y-direction is substantially perpendicular to the X-direction.

The relay optical assembly 440 receives the XY scanned laser pulses 458 from the XY galvo scanning unit 442 and transfers the XY scanned laser pulses 458 to Z stage 466 in a manner that minimizes vignetting. Concave mirror 460 reflects each of the XY scanned laser pulse 458 to produce a converging laser pulses incident on plane mirror 462. Plane mirror 462 reflects the converging XY scanned laser pulse 458 towards plane mirror 464. Between the plane mirror 462 and the plane mirror 464, the XY scanned laser pulse 458 transitions from being convergent to being divergent. The divergent laser pulse 458 is reflected by plane mirror 464 onto concave mirror 461. Concave mirror 461 reflects the laser pulse 458 to produce a collimated laser pulse that is directed to the Z stage 466.

The Z stage 466 receives the XY scanned laser pulses 458 from the relay optical assembly 442. In the illustrated embodiment, the Z stage 466 and the XY stage 468 are coupled to the focusing objective lens 470 and controlled to selectively position the focusing objective lens 470 relative to the ophthalmic lens 410 for each of the XY scanned laser pulses 474 so as to focus the XYZ scanned laser pulse 474 onto a respective targeted sub-volume of the ophthalmic lens 410. The Z stage 466 is controlled to selectively control the depth within the ophthalmic lens 410 to which the laser pulse is focused (i.e., the depth of the sub-surface volume of the ophthalmic lens 410 on which the laser pulse is focused to induce a change in refractive index of the targeted sub-surface volume). The XY stage 468 is controlled in conjunction with control of the XY galvo scanning unit 442 so that the focusing objective lens 470 is suitably positioned for the respective transverse position of each of the XY scanned laser pulses 458 received by the Z stage 466. The focusing objective lens 470 converges the laser pulse onto the targeted sub-surface volume of the lens 410. The patient interface/ophthalmic lens holder 472 restrains the ophthalmic lens 410 in a fixed position to support scanning of the laser pulses 474 by the scanning/interface assembly 438 to form the subsurface optical structures within the ophthalmic lens 410.

Defining subsurface optical elements for a specified optical correction.

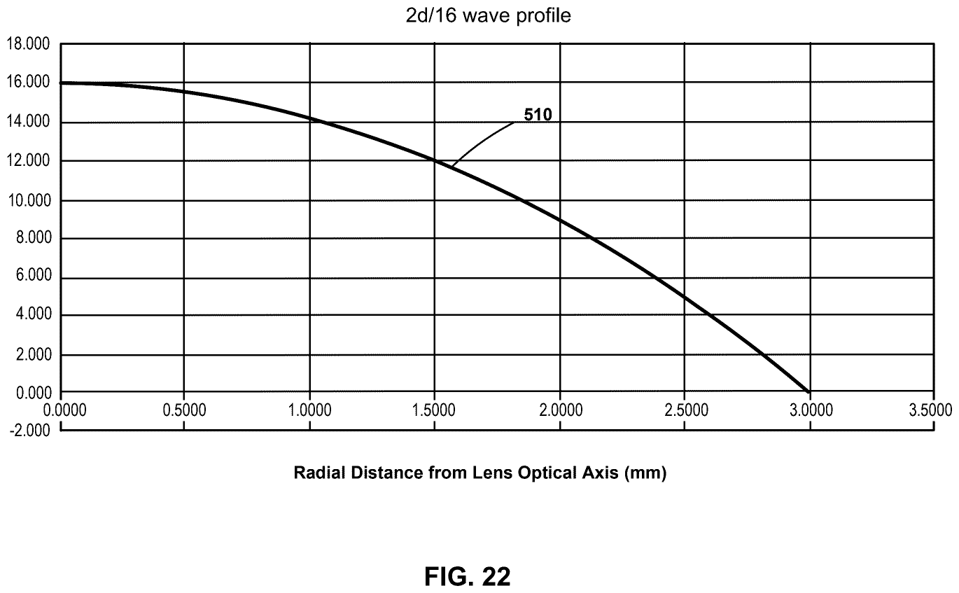

FIG. 22 through FIG. 29 illustrate a process that can be used to define subsurface optical elements for a specified optical correction. While an optical correction configured to create high-quality vision for the patient and/or inhibit progression of myopia in a subject using the approaches described herein may be a combination of any suitable number of low-order optical corrections and/or any suitable number of high-order optical corrections, a single, simple 2 diopter optical correction is illustrated. The same process, however, can be used to define subsurface optical elements for an ophthalmic lens to configure the ophthalmic lens to provide an optical correction to create high-quality vision and/or to inhibit myopia progression (by utilizing any of the myopia inhibiting optical corrections described herein).

FIG. 22 shows a radial variation in units of optical waves of a 2.0 diopter refractive index distribution 510, in accordance with embodiments. The optical waves in this curve correspond to a design wavelength of 562.5 nm. In the illustrated embodiment, the 2.0 diopter refractive index distribution 510 decreases from a maximum of 16.0 waves at the optical axis of an ophthalmic lens down to 0.0 waves at 3.0 mm from the optical axis.

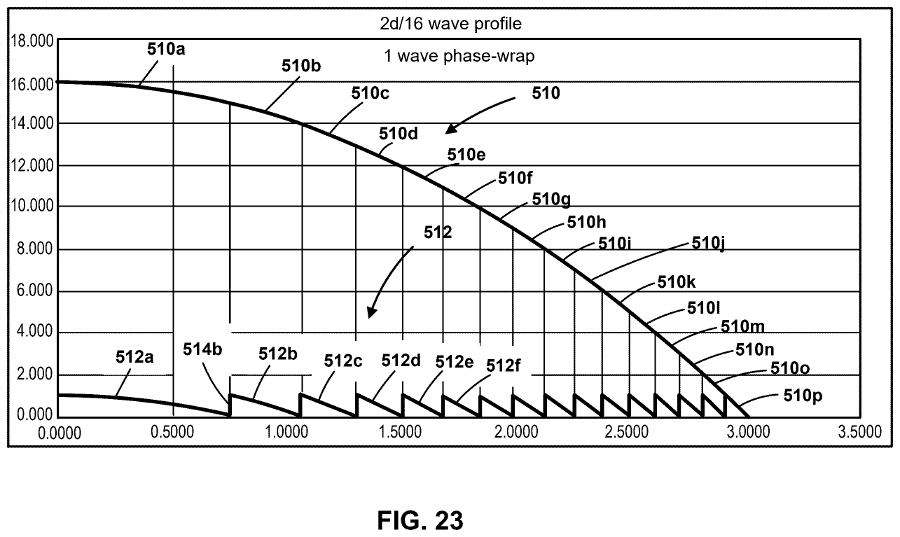

FIG. 23 shows a 1.0 wave phase-wrapped refractive index distribution 512 corresponding to the 2.0 diopter refractive index distribution 510. Each segment of the 1.0 wave phase-wrapped refractive index distribution 512 includes a sloped segment (512a through 512p). Each of all the segments, except the center segment, of the 1.0 wave phase-wrapped refractive index distribution 512 includes an optical phase discontinuity (514b through 514p) with a height equal to 1.0 wave. Each of the sloped segments (512a through 512p) is shaped to match the corresponding overlying segment (510a through 510p) of the 2.0 diopter refractive index distribution 510. For example, sloped segment 512p matches overlying segment 510p; sloped segment 5120 is equal to overlying segment 5100 minus 1.0 wave; sloped segment 512n is equal to overlying segment 510n minus 2.0 waves; sloped segment 512a is equal to overlying segment 510a minus 15.0 waves. Each sloped segment corresponds to a Fresnel zone.

The 1.0 wave height of each of the optical phase discontinuities (514b through 514p) in the distribution 512 results in diffraction at the design wavelength that provides the same 2.0 diopter refractive correction as the 2.0 diopter refractive distribution 510 while limiting maximum optical phase equal to 1.0 wave.

The 1.0 wave phase-wrapped refractive index distribution 512 requires substantially lower total laser pulse energy to induce in comparison to the 2.0 diopter refractive index distribution 510. The area under the 1.0 wave phase-wrapped refractive index distribution 512 is only about 5.2 percent of the area under the 2.0 diopter refractive index distribution 510.

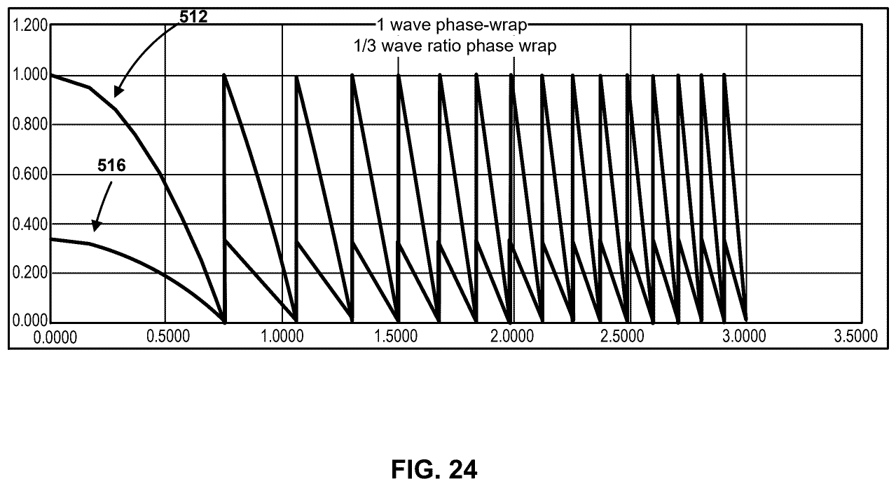

FIG. 24 shows the 1.0 wave phase-wrapped refractive index distribution 512 and an example scaled phase-wrapped refractive index distribution (for a selected maximum wave value) corresponding to the 1.0 wave phase-wrapped refractive index distribution 512. In the illustrated embodiment, the example scaled phase-wrapped refractive index distribution has a maximum wave value of ⅓ wave. Similar scaled phase-wrapped refractive index distributions can be generated for other suitable maximum wave values less than 1.0 wave (e.g., ¾ wave, ⅝ wave, ½ wave, ¼ wave, ⅙ wave). The ⅓ optical wave maximum scaled phase-wrapped refractive index distribution 516 is equal to ⅓ of the 1.0 wave phase-wrapped refractive index distribution 512. The ⅓ optical wave maximum scaled phase-wrapped refractive index distribution 516 is one substitute for the 1.0 wave phase-wrapped refractive index distribution 512 and utilizes a maximum refractive index value that provides a corresponding maximum ⅓ wave optical correction.

The ⅓ optical wave maximum scaled phase-wrapped refractive index distribution 516 requires less total laser pulse energy to induce in comparison with the 1.0 wave phase-wrapped refractive index distribution 512. The area under the ⅓ optical wave maximum scaled phase-wrapped refractive index distribution 516 is ⅓ of the area under the 1.0 wave phase-wrapped refractive index distribution 512. Three stacked layers of the ⅓ wave distribution 516 can be used to produce the same optical correction as the 1.0 wave distribution 512.

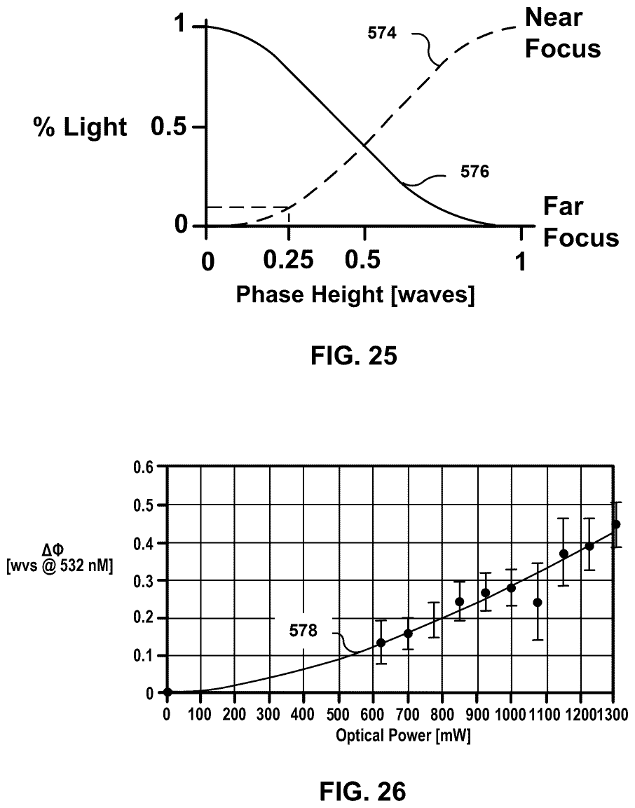

FIG. 25 graphically illustrates diffraction efficiency for near focus 574 and far focus 576 versus optical phase change height. For optical phase change heights less than 0.25 waves, the diffraction efficiency for near focus is only about 10 percent. Near focus diffraction efficiency of substantially greater than 10 percent, however, is desirable to limit the number of layers of the subsurface optical structures that are stacked to generate a desired overall optical correction. Greater optical phase change heights can be achieved by inducing greater refractive index changes in the targeted sub-volumes of the ophthalmic lens 410. Greater refractive index changes in the targeted sub-volumes of the ophthalmic lens 410 can be induced by increasing energy of the laser pulses focused onto the targeted sub-volumes of the ophthalmic lens 410.

FIG. 26 graphically illustrates an example calibration curve 578 for resulting optical phase change height as a function of laser pulse optical power. The calibration curve 578 shows correspondence between resulting optical phase change height as a function of laser average power for a corresponding laser pulse duration, laser pulse wavelength, laser pulse repetition rate, numerical aperture, material of the ophthalmic lens 410, depth of the targeted sub-volume, spacing between the targeted sub-volumes, scanning speed, and line spacing. The calibration curve 578 shows that increasing laser pulse energy results in increased optical phase change height.

Laser pulse energy, however, may be limited to avoid propagation of damage induced caused by laser pulse energy and/or heat accumulation with the ophthalmic lens 410, or even between the layers of the subsurface optical elements. In many instances, there is no observed damage during formation of the first two layers of subsurface optical elements and damage starts to occur during formation of the third layer of subsurface optical elements. To avoid such damage, the subsurface optical elements can be formed using laser pulse energy below a pulse energy threshold of the material of the ophthalmic lens 410. Using lower pulse energy, however, increases the number of layers of the subsurface optical elements required to provide the desired amount of resulting optical phase change height, thereby adding to the time required to form the total number of subsurface optical elements 412 employed.

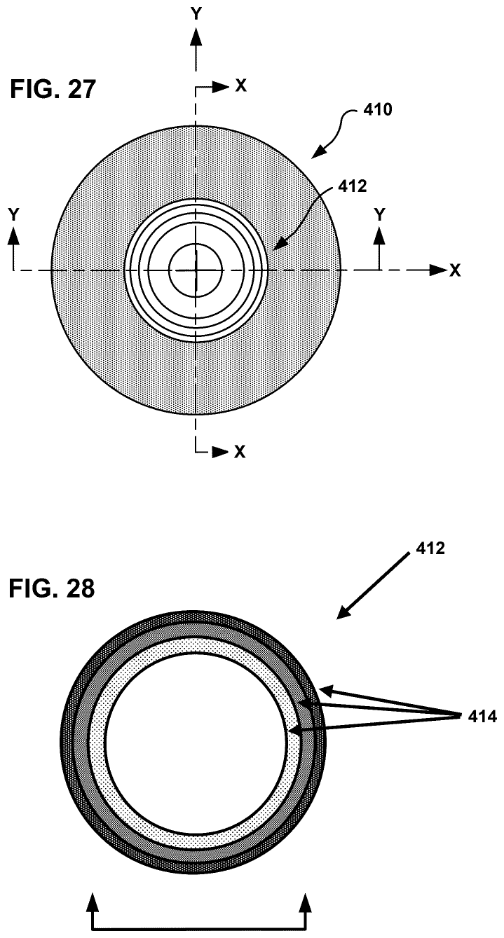

FIG. 27 is a plan view illustration of an ophthalmic lens 410 that includes one or more subsurface optical elements 412 with refractive index spatial variations, in accordance with embodiments. The one or more subsurface elements 12 described herein can be formed in any suitable type of ophthalmic lens including, but not limited to, intra-ocular lenses, contact lenses, corneas, spectacle lenses, and native lenses (e.g., a human native lens). The one or more subsurface optical elements 412 with refractive index spatial variations can be configured to provide a suitable refractive correction configured to create high-quality vision for the patient and/or inhibit progression of myopia as described herein. Additionally, the one or more subsurface optical elements 412 with refractive index spatial variations can be configured to provide a suitable refractive correction for each of many optical aberrations such as astigmatism, myopia, hyperopia, spherical aberrations, coma and trefoil, as well as any suitable combination thereof.

FIG. 28 is a plan view illustration of one of the subsurface optical elements 412 of the ophthalmic lens 410. The illustrated subsurface optical elements 412 occupies a respective volume of the lens 410, which includes associated sub-volumes of the lens 410. In many embodiments, the volume occupied by one of the optical elements 412 includes first, second, and third portions 414. Each of the first, second, and third portions 414 can be formed by focusing suitable laser pulses inside the respective portion 414 so as to induce changes in refractive index in sub-volumes of the lens 410 that make up the respective portion 414 so that each portion 414 has a respective refractive index distribution.

In many embodiments, a refractive index distribution is defined for each portion 414 that forms the subsurface optical structures 412 so that the resulting subsurface optical structures 412 provide a desired optical correction. The refractive index distribution for each portion 414 can be used to determine parameters (e.g., laser pulse power (mW), laser pulse width (fs)) of laser pulses that are focused onto the respective portions 414 to induce the desired refractive index distributions in the portions 414.

While the portions 414 of the subsurface optical structures 412 have a circular shape in the illustrated embodiment, the portions 414 can have any suitable shape and distribution of refractive index variations. For example, a single portion 414 having an overlapping spiral shape can be employed. In general, one or more portions 414 having any suitable shapes can be distributed with intervening spaces so as to provide a desired optical correction for light incident on the subsurface optical structure 412.

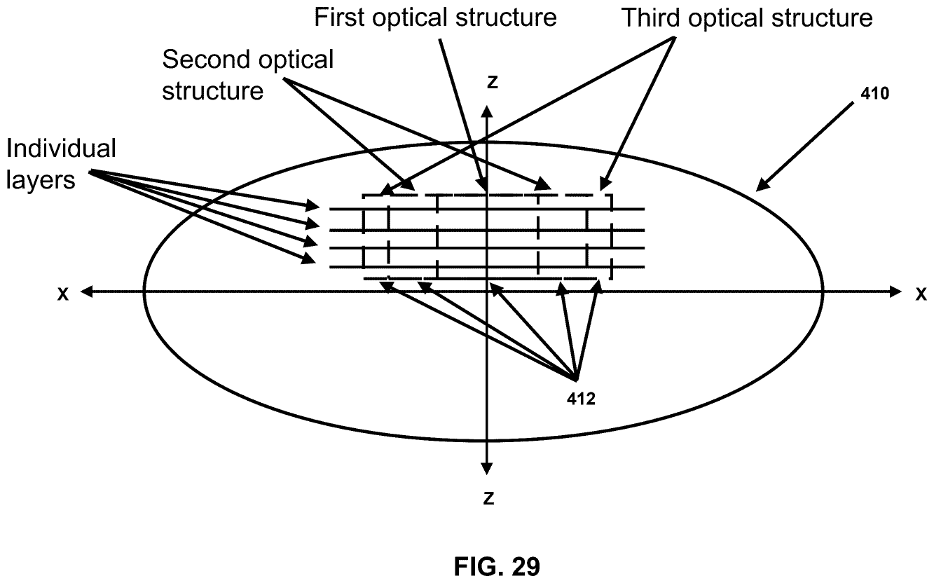

FIG. 29 illustrates an embodiment in which the subsurface optical elements 412 are comprised of several stacked layers that are separated by intervening layer spaces. In the illustrated embodiment, the subsurface optical elements 412 have a spatial distribution of refractive index variations. FIG. 29 is a side view illustration of an example distribution of refractive index variations in the subsurface optical elements 412. In the illustrated embodiment, the subsurface optical elements 412 can be formed using a raster scanning approach in which each layer is sequentially formed starting with the bottom layer and working upward. For each layer, a raster scanning approach can sequentially scan the focal position of the laser pulses along planes of constant Z-dimension while varying the Y-dimension and the X-dimension so that the resulting layers have the flat cross-sectional shapes shown in FIG. 29, which shows a cross-sectional view of the ophthalmic lens 410. In the raster scanning approach, timing of the laser pulses can be controlled to direct each laser pulse onto a targeted sub-volume of the ophthalmic lens 410 and not direct laser pulses onto non-targeted sub-volumes of the ophthalmic lens 410, which include sub-volumes of the ophthalmic lens 10 that do not form any of the subsurface optical elements 412, such as the intervening spaces between the adjacent stacked layers that can form the subsurface optical elements 412.

In the illustrated embodiment, there are three annular subsurface optical elements 412 with distributions of refractive index spatial variations. Each of the illustrated subsurface optical elements 412 has a flat layer configuration and can be comprised of one or more layers. If the subsurface optical structures are comprised of more than one layer, the layers can be separated from each other by an intervening layer spacing. Each of the layers, however, can alternatively have any other suitable general shape including, but not limited to, any suitable non-planar or planar surface. In the illustrated embodiment, each of the subsurface optical elements 412 has a circular outer boundary. Each of the subsurface optical elements 412, however, can alternatively have any other suitable outer boundary shape. Each of the subsurface optical elements 412 can include two or more separate portions 414 with each covering a portion of the subsurface optical elements 412.

### NON-LIMITING EXAMPLE EMBODIMENTS

Example 1 is a contact lens formed from a contact lens material having a lens material refractive index. The contact lens includes a central zone and an annular zone. The central zone includes a central zone subsurface diffractive optical structure comprising central zone refractive indices that differ from the lens material refractive index. The central zone subsurface diffractive optical structure is configured to produce a central zone wavefront that comprises a diffractive component. The annular zone surrounds the central zone. The annular zone comprises an annular zone subsurface non-diffractive optical structure comprising annular zone refractive indices that differ from the lens material refractive index. The annular zone subsurface non-diffractive optical structure is configured to produce an annular zone wavefront configured to combine with the central zone wavefront to enhance image quality. Example 2 is a contact lens in accordance with example 1, wherein the annular zone wavefront is configured to combine with the central zone wavefront via constructive interference. Example 3 is a contact lens in accordance with example 2, wherein the annular zone is configured to induce a constant piston optical correction essentially throughout the annular zone. Example 4 is a contact lens in accordance with example 3, wherein: (a) the central zone subsurface diffractive optical structure has a phase-wrapped configuration that induces varying optical wave changes and (b) the constant piston optical correction induces an optical wave change within 0.2 optical waves of a median of the varying optical wave changes. Example 5 is a contact lens in accordance with example 4, wherein the constant piston optical correction provides an optical wave change within 0.1 optical waves of the median of the varying optical wave changes. Example 6 is a contact lens in accordance with example 4, wherein the varying optical wave changes are within a range from 0.0 waves to 1.0 waves. Example 7 is a contact lens in accordance with example 6, wherein the varying optical wave changes are within a range from 0.0 waves to 0.75 waves. Example 8 is a contact lens in accordance with example 1, wherein: (a) the central zone subsurface diffractive optical structure has a phase-wrapped configuration that induces varying optical wave changes and (b) an annular zone subsurface non-diffractive optical structure produces optical wave changes within 0.2 optical waves of a median of the varying optical wave changes. Example 9 is a contact lens in accordance with example 8, wherein the annular zone subsurface non-diffractive optical structure produces optical wave changes within 0.1 optical waves of the median of the varying optical wave changes. Example 10 is a contact lens in accordance with example 8, wherein the varying optical wave changes are within a range from 0.0 waves to 1.0 waves. Example 11 is a contact lens in accordance with example 10, wherein the varying optical wave changes are within a range from 0.0 waves to 0.75 waves.

Example 12 is a contact lens in accordance with any one of example 1 through example 11, wherein: (a) the central zone subsurface diffractive optical structure has an outer diameter of at least 3 mm and (b) the annular zone subsurface non-diffractive optical structure has an outer diameter of at least 4 mm. Example 13 is a contact lens in accordance with any one of example 1 through example 11, wherein: (a) the central zone subsurface diffractive optical structure has an outer diameter of at least 4 mm and (b) the annular zone subsurface non-diffractive optical structure has an outer diameter of at least 5.5 mm. Example 14 is a contact lens in accordance with any one of example 1 through example 11, wherein the central zone wavefront is configured to treat presbyopia. Example 15 is a contact lens in accordance with any one of example 1 through example 11, wherein the central zone wavefront is configured to treat presbyopia. Example 16 is a contact lens in accordance with example 15, wherein the annular zone subsurface non-diffractive optical structure provides at least a 50 percent increase in Strehl ratio at 555 nm wavelength for distance vision relative to if the annular zone was configured to provide no optical correction. Example 17 is a contact lens in accordance with example 15, wherein the annular zone subsurface non-diffractive optical structure provides at least a 100 percent increase in Strehl ratio at 555 nm wavelength for distance vision relative to if the annular zone was configured to provide no optical correction. Example 18 is a contact lens in accordance with example 15, wherein the annular zone subsurface non-diffractive optical structure provides at least a 50 percent increase in Retinal Image Quality at 555 nm wavelength for distance vision relative to if the annular zone was configured to provide no optical correction.

Example 19 is a contact lens formed from a contact lens material having a lens material refractive index. The contact lens includes a central zone and an annular zone. The central zone comprising a central zone subsurface diffractive optical structure comprising central zone refractive indices that differ from the lens material refractive index. The central zone subsurface diffractive optical structure is configured to produce a central zone wavefront that comprises a diffractive component. The central zone subsurface diffractive optical structure has a phase-wrapped configuration that induces varying optical wave changes. A median of the varying optical wave changes is within 0.1 optical waves of a whole number of optical waves. The annular zone surrounds the central zone. The annular zone is configured to not induce any change in optical wave outside a range from −0.05 optical waves to 0.05 optical waves. Example 20 is a contact lens in accordance with example 19, wherein the annular zone is configured to not induce a change in optical waves. Example 21 is a contact lens in accordance with example 19, wherein the varying optical wave changes induced by the central zone cover a range of optical waves covering a span of at least 0.3 optical waves. Example 22 is a contact lens in accordance with example 19, wherein the varying optical wave changes induced by the central zone cover a range of optical waves covering a span of at least 0.5 optical waves. Example 23 is a contact lens in accordance with example 19, wherein the varying optical wave changes are within a range from 0.0 waves to 1.0 waves. Example 24 is a contact lens in accordance with example 19, wherein the varying optical wave changes are within a range from 0.0 waves to 0.75 waves.

Example 25 is a contact lens in accordance with any one of example 19 through example 24, wherein: (a) the central zone subsurface diffractive optical structure has an outer diameter of at least 3 mm and (b) the annular zone has an outer diameter of at least 4 mm. Example 26 is a contact lens in accordance with any one of example 19 through example 24, wherein: (a) the central zone subsurface diffractive optical structure has an outer diameter of at least 4 mm and (b) the annular zone has an outer diameter of at least 5.5 mm. Example 27 is a contact lens in accordance with any one of example 19 through example 24, wherein the central zone wavefront is configured to treat presbyopia. Example 28 is a contact lens in accordance with example 27, wherein the central zone wavefront is configured to treat presbyopia.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A contact lens formed from a contact lens material having a lens material refractive index, the contact lens comprising:
a central zone comprising a central zone subsurface diffractive optical structure comprising central zone refractive indices that differ from the lens material refractive index, wherein the central zone subsurface diffractive optical structure is configured to produce a central zone wavefront that comprises a diffractive component; and
annular zone surrounds the central zone, wherein the annular zone comprises an annular zone subsurface non-diffractive optical structure comprising annular zone refractive indices that differ from the lens material refractive index, wherein the annular zone subsurface non-diffractive optical structure is configured to produce an annular zone wavefront configured to combine with the central zone wavefront to enhance image quality, wherein the annular zone wavefront is configured to combine with the central zone wavefront via constructive interference, and wherein the annular zone is configured to induce a constant piston optical correction essentially throughout the annular zone.

2.-3. (canceled)

4. The contact lens of claim 1, wherein:
the central zone subsurface diffractive optical structure has a phase-wrapped configuration that induces varying optical wave changes; and
the constant piston optical correction induces an optical wave change within 0.2 optical waves of a median of the varying optical wave changes.

5. The contact lens of claim 4, wherein the constant piston optical correction provides an optical wave change within 0.1 optical waves of the median of the varying optical wave changes.

6. The contact lens of claim 4, wherein the varying optical wave changes are within a range from 0.0 waves to 1.0 waves.

7. The contact lens of claim 6, wherein the varying optical wave changes are within a range from 0.0 waves to 0.75 waves.

8. A contact lens formed from a contact lens material having a lens material refractive index, the contact lens comprising:
a central zone comprising a central zone subsurface diffractive optical structure comprising central zone refractive indices that differ from the lens material refractive index, wherein the central zone subsurface diffractive optical structure is configured to produce a central zone wavefront that comprises a diffractive component, wherein the central zone subsurface diffractive optical structure has a phase-wrapped configuration that induces varying optical wave changes; and
annular zone surrounds the central zone, wherein the annular zone comprises an annular zone subsurface non-diffractive optical structure comprising annular zone refractive indices that differ from the lens material refractive index, wherein the annular zone subsurface non-diffractive optical structure is configured to produce an annular zone wavefront configured to combine with the central zone wavefront to enhance image quality, wherein the annular zone subsurface non-diffractive optical structure produces optical wave changes within 0.2 optical waves of a median of the varying optical wave changes.

9. The contact lens of claim 8, wherein the annular zone subsurface non-diffractive optical structure produces optical wave changes within 0.1 optical waves of the median of the varying optical wave changes.

10. The contact lens of claim 8, wherein the varying optical wave changes are within a range from 0.0 waves to 1.0 waves.

11. The contact lens of claim 10, wherein the varying optical wave changes are within a range from 0.0 waves to 0.75 waves.

12.-15. (canceled)

16. The contact lens of claim 8, wherein the annular zone subsurface non-diffractive optical structure provides at least a 50 percent increase in Strehl ratio at 555 nm wavelength for distance vision relative to if the annular zone was configured to provide no optical correction.

17. The contact lens of claim 8, wherein the annular zone subsurface non-diffractive optical structure provides at least a 100 percent increase in Strehl ratio at 555 nm wavelength for distance vision relative to if the annular zone was configured to provide no optical correction.

18. The contact lens of claim 8, wherein the annular zone subsurface non-diffractive optical structure provides at least a 50 percent increase in Retinal Image Quality at 555 nm wavelength for distance vision relative to if the annular zone was configured to provide no optical correction.

19. A contact lens formed from a contact lens material having a lens material refractive index, the contact lens comprising:
a central zone comprising a central zone subsurface diffractive optical structure comprising central zone refractive indices that differ from the lens material refractive index, wherein the central zone subsurface diffractive optical structure is configured to produce a central zone wavefront that comprises a diffractive component, wherein the central zone subsurface diffractive optical structure has a phase-wrapped configuration that induces varying optical wave changes, and wherein a median of the varying optical wave changes is within 0.1 optical waves of a whole number of optical waves; and
an annular zone surrounds the central zone, wherein the annular zone is configured to not induce any change in optical wave outside a range from −0.05 optical waves to 0.05 optical waves.

20. The contact lens of claim 19, wherein the annular zone is configured to not induce a change in optical waves.

21. The contact lens of claim 19, wherein the varying optical wave changes induced by the central zone cover a range of optical waves covering a span of at least 0.3 optical waves.

22. The contact lens of claim 19, wherein the varying optical wave changes induced by the central zone cover a range of optical waves covering a span of at least 0.5 optical waves.

23. The contact lens of claim 19, wherein the varying optical wave changes are within a range from 0.0 waves to 1.0 waves.

24. The contact lens of claim 23, wherein the varying optical wave changes are within a range from 0.0 waves to 0.75 waves.

25. The contact lens of claim 19, wherein:
the central zone subsurface diffractive optical structure has an outer diameter of at least 3 mm; and
the annular zone has an outer diameter of at least 4 mm.

26.-27. (canceled)

28. The contact lens of claim 19, wherein the central zone wavefront is configured to treat presbyopia.
